(19) United States
(12) Patent Application Publication
(10) Pub. No.: US 2026/0087876 A1
(43) Pub. Date: Mar. 26, 2026

(54) ELECTRONIC GAMING TERMINAL WITH TRUSTED COMPONENT SYSTEM

(71) Applicant: Savvy Dog Systems, LLC, Duluth, GA (US)

(72) Inventors: Jerry Wasinger, Duluth, GA (US); Donald McNeill, Duluth, GA (US); Jose Rosario, Duluth, GA (US)

(21) Appl. No.: 19/336,799

(22) Filed: Sep. 23, 2025

Related U.S. Application Data
(60) Provisional application No. 63/699,264, filed on Sep. 26, 2024.

(51) Int. Cl. G07F 17/32

(52) U.S. Cl. CPC G07F 17/3225

(57) ABSTRACT

Systems and methods to enhance validation of trusted components of an electronic gaming terminal are described. The system includes a platform controller, and one or more component controllers. The platform controller generates and shares an encryption key with the component controllers. The platform controller validates the component controller by transmitting encrypted first data set, receiving encrypted second data set, and validating the component controller based on decrypting the second data set. In response to the component controller being deemed invalid, the platform controller prevents launching of a gaming application.

### FIELD OF DISCLOSURE

The present disclosure is directed toward systems and methods for authenticating hardware components of electronic devices and/or systems, including devices and methods for authenticating new or replacement components of an electronic gaming terminal.

### BACKGROUND

Amusement and entertainment type electronic games, played via a gaming terminal or systems, have become very popular with the public. The play on such gaming terminals can involve a task, game, play, contest, competition or tournament in which the player actively participates to win a prize. As the popularity of these games has increased, so has the use of after-market and non-authorized components in such games. Some of the hardware components used in an electronic gaming cabinet can be obtained from one or more vendors, which may not be of the same quality and/or not function as OEM components. These components include displays, bill acceptors, lighting controllers, and thermal printers. Other components such as an input output (I/O) board, a motherboard, etc., can be reverse engineered and copied to enable a third party make unauthorized modifications to electronic gaming terminals that are deployed in the field. Such unauthorized modifications can potentially hamper operation of the device, lead to unfair game play, and/or create other undesirable effects.

### BRIEF SUMMARY

Aspects of the present disclosure recognize a need in the art for improved verification of authorized components for use in an electronic system or device that can be located at a remote location/or and can be under control and/or operation by a third party. In embodiments, the electronic device can comprise a gaming terminal.

Generally, aspects of the present disclosure are directed to a trusted component platform may ensure that the components used in the electronic gaming terminal are not replaced with unauthorized products or electronic circuit boards. Instead, messages with strong encryption will be exchanged between critical components inside the cabinet to validate that those components are authentic (e.g., the same components that were installed in the factory or in the field by authorized personnel). Other non-critical components such as bill acceptors, printers and displays may communicate in the electronic gaming terminal via conventional communication channels, and may also be validated although with non-encrypted means.

Aspects of the trusted component platform described herein may ensure that electronic gaming terminal components and replacements therefor remain genuine, to improve reliability, ensure a consistent and controlled set of component combinations, reduce field service costs, and prevent theft or foul play.

In an aspect of the present disclosure, a method is performed by a platform controller that, in various embodiments, can comprise a first circuit board (e.g., a motherboard) of a gaming system. The method involves transmitting an encryption key in a secure manner to a component controller, which, in embodiments, can include another circuit board (e.g., a second circuit board) within the cabinet. In embodiments, such a transmission may be done over a communication bus. Once the encryption key is shared to the second circuit board, the first circuit board and second circuit board may use this common encryption key to encrypt messages between the first circuit board and second circuit board in a subsequent communication session, to validate the second circuit board.

In embodiments, to perform validation, the first circuit board encrypts a first data set using a default encryption key and transmits the encrypted data to the second circuit board via the communication bus. Subsequently, the second circuit board receives the encrypted first data set from the first circuit board and decrypts it using the same default encryption key. The second circuit board then reads the data. In response, the second circuit board encrypts a second data set (e.g., a response) and transmits the encrypted second data set back to the first circuit board, using the same default encryption key. The first circuit board receives the encrypted second data set, and decrypts it using the default encryption key. The first circuit board reads the second data set to determine whether the second data set matches what is expected. If the data set matches the expected response, the first circuit board deems the second circuit board to be valid. If not, the first circuit board deems the second circuit board to be invalid. In response to a determination that the second circuit board is invalid, the first circuit board can prevent the gaming application from launching.

In this manner, if an electronic gaming terminal has an unsupported or tampered component that may be determined to be necessary to play of a gaming application, recording of receipts, reporting, display of the game play, or other tasks or combinations thereof, the electronic gaming terminal can be directed to block or cease to allow game play, reducing the risk of theft, inconsistent or invalid game play, or other faulty uses/operations. By preventing the launching of the gaming application, the system can prevent the use of altered and/or invalid hardware or software that could be harmful to the operation of the gaming terminal and could create issues for the players (e.g., create an unfair advantage against them) and/or an operator of the electronic gaming terminal.

In another embodiment, the electronic gaming terminal includes a platform controller configured to communicate with and provide operational instructions and receive feedback from a series of components of the electronic gaming terminal. In embodiments, each of the components in communication with the platform controller can include a component controller that can comprise a circuit board with embedded software, and can include components such as a cabinet lighting controller, an input output (I/O) controller, a power management controller, or a player deck controller of the electronic gaming cabinet.

In an embodiment, the platform controller can comprise a first circuit board and can include programming or instructions for monitoring, recording and controlling operations of the electronic gaming terminal. The platform controller further can be configured to perform an initial exchange of data with each of the component controllers, which, in embodiments, can comprise a plurality of second circuit boards that each can include programming and/or control instructions for controlling operation of their associated component(s). The component controllers will be in communication with the platform controller, and further can be programmed to respond to validation requests from the platform controller, and in embodiments, can include programming configured to repeat a validation process each time a detection of a changed or new component is made.

In embodiments, the plurality of component controllers (e.g., one or more second or additional circuit boards) may be determined to be those that are deemed to be critical to ensure the proper operation of the gaming system, and to prevent tampering of the gaming system. In an embodiment, if any of the second circuit boards fail validation, the platform controller can cause the electronic gaming terminal to refrain from launching the gaming application.

In an embodiment, the encryption key is shared in an encrypted communication session. The platform controller may generate an encryption key for use in a subsequent session. The new session encryption key may then be transmitted by the platform controller to the second circuit board using the current encryption session key. In an embodiment, both the platform controller and a queried component controller may have the same session key, using the current session key to encrypt and decrypt the new session encryption key, so that sharing of the new session encryption key is performed in a secure manner.

To generate the session key on both the platform controller and component controller, the component controller may access a unique ID stored on the component controller and apply a hashing algorithm (e.g., programmed in protected flash memory) to generate the session key locally. The component controller may share the unique ID with platform. The platform controller also uses the same default hashing algorithm (e.g., also programmed in local protected flash memory of the first circuit board) to generate the same session key using the unique ID shared from the component controller. The component controller uses the session key to decrypt the received encryption key and stores the received encryption key locally for future use. The component controller also may subsequently use the stored encryption key to decode messages such as a validation request, from the first circuit board.

In such a manner, the encryption key is shared in a secure manner and cannot be directly observed on the communication bus without the session key. The session key cannot be stolen off the communication bus, because the session key itself is not shared on the bus, rather, the unique ID is shared and the both the platform controller and component controller may use a locally protected hash algorithm to generate the session key. In an embodiment, the encryption key is used in an advanced encryption method to encrypt the unsecured data into a secure data set.

In an embodiment, if a component controller fails validation, the platform controller may set a default encryption key to be used for validation on a subsequent start up. Each of the second circuit boards may be configured to fall back on the same default encryption key in case a received validation request fails with the non-default encryption session key.

The communication bus may be a universal serial bus (USB). The platform controller may exchange encrypted messages with each of the one or more second circuit boards upon start up (e.g., power up, or reset) of the electronic gaming cabinet. In response to all the one or more second circuit boards being validated, the platform controller may launch the gaming application, then display the application graphical content to the display.

### BRIEF DESCRIPTION OF THE DRAWINGS

To easily identify the discussion of any element or act, the most significant digit or digits in a reference number refer to the figure number in which that element is first introduced.

FIG. 1A depicts an example of an electronic gaming terminal.

FIG. 1B depicts an example embodiment of a control and communication arrangement for an electronic gaming terminal with enhanced component validation of components in accordance with the principles of the present disclosure.

FIG. 2 shows a flow diagram depicting an example embodiment of a method or validating trusted components of an electronic gaming terminal in accordance with the principles of the present disclosure.

FIG. 3 depicts an example embodiment of controls of an electronic gaming terminal with enhanced component validation in accordance with the principles of the present disclosure.

FIG. 4 shows an example embodiment of key generation and sharing between the platform and component controllers in accordance with the principles of the present disclosure.

FIG. 5 shows a flow diagram depicting an example embodiment of a method for validating trusted components of an electronic gaming terminal in accordance with the principles of the present disclosure.

FIG. 6 depicts an example embodiment electronic gaming cabinet with an example arrangement of trusted components in accordance with the principles of the present disclosure.

FIG. 7 depicts an example embodiment of an electronic gaming cabinet with validation of components in accordance with the principles of the present disclosure.

FIG. 8 shows an example embodiment of a power management controller in accordance with the principles of the present disclosure.

FIG. 9 shows an example embodiment of a player deck controller in accordance with the principles of the present disclosure.

FIG. 10 shows an example embodiment of an architecture for processor components in accordance with the principles of the present disclosure.

FIG. 11 shows a diagram illustrating an example embodiment of secure encryption key sharing in accordance with the principles of the present disclosure.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely to provide a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such a term to mean based on the contextual use of the term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

Embodiments of the present disclosure are directed to electronic devices and systems incorporating a trusted component security system. In embodiments, for purposes of illustration, the electronic devices as discussed herein can include an amusement or gaming system, machine, or terminal.

Aspects of the present disclosure are directed to devices, systems and methods configured to prevent operation of an electronic gaming terminal if unauthorized products or electronic circuit boards are attempted to be used in place of existing, authorized components of the electronic gaming terminal (e.g., various unauthorized hardware components being swapped into the electronic game terminal for use therewith). This reduces the risk that a user is unjustly enriched or unjustly hampered in game play, through altering the hardware or software in the electronic gaming terminal. Preventing such tampering also improves consistency among deployed electronic gaming terminals by ensuring that hardware and software with noticeably different characteristics are not installed on different electronic gaming terminals.

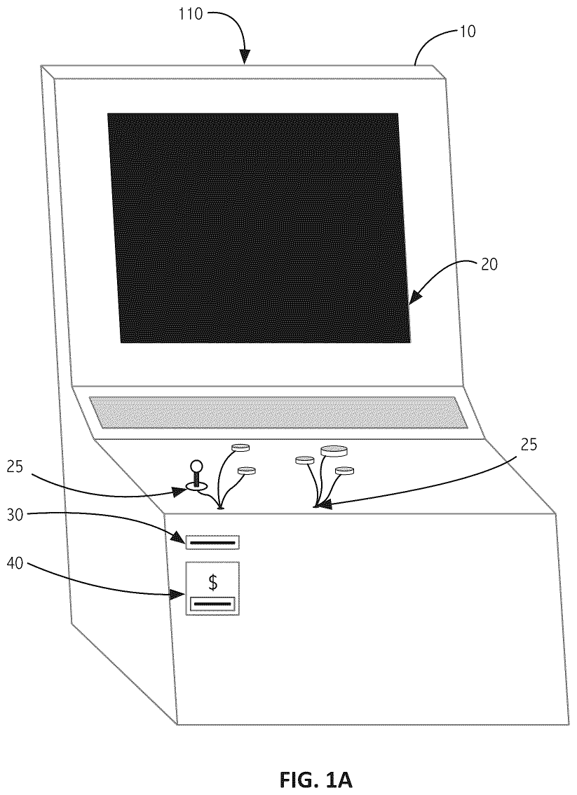

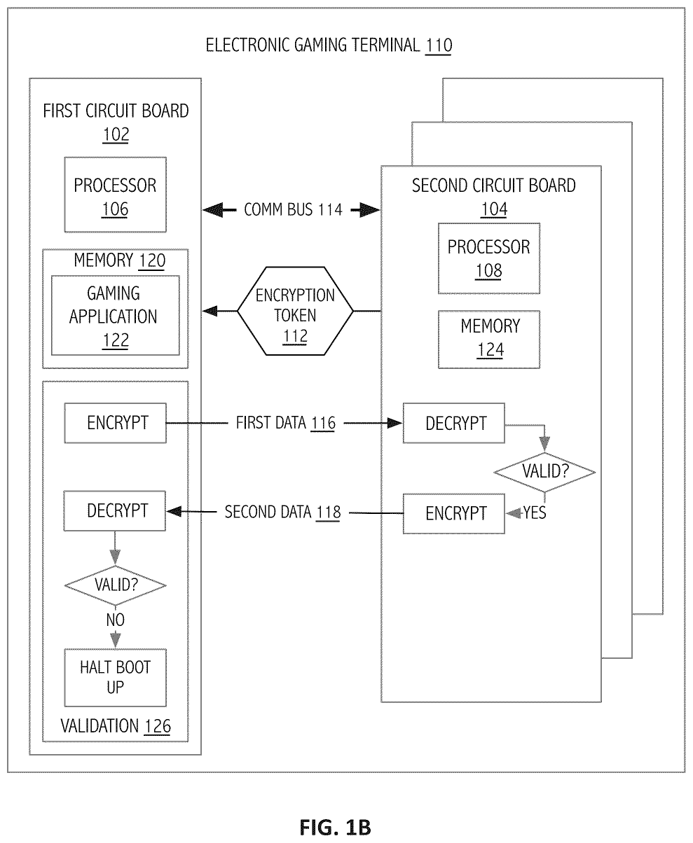

FIGS. 1A-1B depicts an example of an electronic gaming terminal 110 with an enhanced trusted component system for validation of a plurality of components of the electronic gaming terminal, in accordance with an embodiment. Electronic gaming terminal 110 may comprise an enclosure or cabinet 10 that houses a platform controller platform controller and one or more component controllers. In embodiments, the electronic gaming terminal can include a display screen or monitor 20, one or more speakers, a series of player controls (e.g., buttons, a joystick, etc.) 25 and a payment or credit acceptor (e.g., a bill acceptor, card reader, etc.).

In some embodiments, as shown in FIG. 1B, the platform controller 102 may be referred to as a first circuit board or a motherboard. In embodiments, the platform controller may comprise a processor 106 coupled to memory 120 that stores a gaming application 122. As a non-limiting example, in embodiments in which the electronic device or system includes a gaming terminal, it can operate a gaming application 122 that may comprise a skill-based game. In embodiments, the platform controller 102 may include programming or instructions for operating various functions of the electronic gaming terminal, including, in embodiments, having the responsibility of launching and running the gaming application 122, which may include presenting the gaming application 122 to a display, reading user inputs during game play, and responding to user inputs within the gaming application 122 during game play, to determine if one or more skill-based milestones are met. The platform controller 102 may also perform high level operations in the electronic gaming terminal 110 by interfacing with each of the other components.

The one or more component controllers 104 each can represent a trusted component (one that is deemed to be critical to operation or to fair game play) and is therefore validated prior to start-up of gaming application 122. For example, in embodiments, the component controller 104 may represent a cabinet lighting controller that is configured to operate lighting of the electronic gaming terminal, an input output (I/O) controller that is configured to route input and output signals of the electronic gaming terminal, a power management controller that is configured to operate one or more power supplies of the electronic gaming terminal, a player deck controller that is configured to receive user inputs associated with gameplay of the gaming application, or trusted component within the electronic gaming terminal 110.

While embodiments are described with reference to particular modules or controllers, functions described may be performed by any suitable number or arrangement of modules, components, or combinations thereof. Modifications, adaptations, and equivalent arrangements will be apparent to those skilled in the art. Embodiments may be implemented in hardware, software, or any suitable combination.

In embodiments, the component controller 104 can comprise a circuit board that comprises at least one processor 108, which may be a microprocessor, and a memory 124 which may comprise one or more different kinds of computer-readable memory (e.g., volatile, non-volatile, read-only memory (ROM), flash memory, random access memory (RAM), registers, etc.).

The platform controller 102 may be communicatively coupled with the component controller 104 through a communication bus 114. In an embodiment, communication bus 114 may be a serial communication bus such as a universal serial bus (USB) or another type of communication bus. In such a case, the circuit boards may communicate over the communication bus 114 using USB protocol.

The platform controller 102 may request, over communication bus 114, an encryption token 112 from the component controller 104 of the electronic gaming terminal 110 that is used to derive the session encryption key. Platform controller 102 may maintain an identical version of the encryption token 112 in memory 120. The component controller 104 may store this encryption token 112 in memory 124. In an embodiment, this encryption token 112 may be shared from the component controller in an encrypted manner using a default session key, as described in other sections. This encryption token installation operation may be performed at a factory-level, or during maintenance by authorized personnel.

The platform controller 102 may perform a validation process 126 of the component controller 104. This process validates whether component controller 104 is authentic (e.g., the same circuit board that was installed in the electronic gaming terminal 110 by authorized personnel) or an imposter board that was potentially swapped into the electronic gaming terminal 110 without authorization. This validation process 126 may be performed on start-up (e.g., power up, reset, etc.) of the electronic gaming terminal 110. The validation process 126 may be performed prior to launching of the gaming application 122.

The validation process 126, includes encrypting a first data set 116 with the encryption key 112. This first data set 116 may be referred to as payload of an authentication request. The first data set may be one or more agreed upon fields with agreed upon format, order, and/or values that component controller 104 is programmed to receive and decrypt using the stored encryption key 112.

The component controller 104 decrypts the encrypted first data set 116 and reads the unencrypted first data set to determine if it is valid. This may include comparing the first data set to expected values or reading instructions in the first data set. Without the encryption key 112, component controller 104 would be incapable of reading the first data set, which prevents unauthorized boards that are without the encryption key from making sense of the validation request. In response to decrypting and reading the first data set 116, the component controller 104 may encrypt second data set 118 using the encryption key 112 and transmit this encrypted second data set 118 to the platform controller 102. In embodiments, the second data set may be configured as a payload of an authentication response. In some embodiments, the Second data set 118 may similarly be generated with one or more agreed upon values in an agreed upon order or format, that the platform controller 102 is adapted to receive to validate component controller 104.

Continuing the validation process 126, in embodiments, the platform controller 102 receives the encrypted second data set from the component controller 104 over the communication bus 114. The platform controller 102 decrypts this encrypted second data set 118 using encryption key 112. Platform controller 102 can further determines whether the component controller 104 (e.g., a new circuit board or other control of a component that is part of or is connected to the electronic gaming terminal) is valid based on decrypting the encrypted second data set with the encryption key.

For example, if the decryption of the second data set results in unrecognizable data (e.g., unexpected one or more values in one or more fields), then the component controller 104 may be deemed invalid. Additionally, or alternatively, if the component controller 104 fails to respond (e.g., second data set is not received within a threshold time period), then the component controller 104 may be deemed invalid. In response the component controller of the gaming cabinet being invalid, the platform controller 102 prevents launching of the gaming application 122. In response to the component controller 104 being valid, the platform controller 102 may launch the gaming application 122 and present it to one or more displays.

In an embodiment, the component controller 104 can be one of a plurality of second circuit boards 104, each configured to perform a different operation within the electronic gaming terminal 110, such as, for example, a cabinet lighting controller that is configured to operate lighting of the electronic gaming terminal, an input output (I/O) controller that is configured to route input and output signals of the electronic gaming terminal, a power management controller that is configured to operate one or more power supplies of the electronic gaming terminal, and a player deck controller that is configured to receive user inputs associated with gameplay of the gaming application.

In embodiments, the platform controller 102 may perform the validation process 126 on all the component controllers each time a new component/new component controller 104 is detected until all component controllers are validated. In response to all the component controllers being validated, platform controller 102 may launch gaming application 122. Otherwise, the platform controller 102 may halt the startup process and not launch the gaming application 122.

In some embodiments, an alert or security message can be displayed on a display screen of the electronic gaming terminal, for example, warning that an unauthorized or possibly defective component is present affecting operation of the game. In addition, or alternatively, if the gaming terminal is connected to the internet, a message can be sent to an operator or owner of the electronic gaming terminal, or an OEM or licensor for the electronic gaming terminal to provide an alert that a change to the electronic gaming terminal and may include installation of an unauthorized component.

Still further, in other embodiments, the security measures provided by the trusted component system can operate to halt or block launch of the gaming application and/or use of the electronic gaming terminal when the platform controller (e.g., the motherboard or first circuit board) has been changed, such as by being swapped or re-programmed. In such an event, the swapped or re-programmed platform controller (e.g., motherboard or a first circuit board) will not be able to perform a validation procedure with the controller components, which, in embodiments, can include programming or instructions configured generally block or otherwise prevent their operation unless the validation process is completed. As a result, the gaming application and/or various components of the electronic gaming terminal such as the display screen, player controllers, etc. may be rendered inoperable.

The electronic gaming terminal 110 and security measures taken by the platform controller 102 and component controller 104 enhance security in electronic gaming systems, ensuring that only authorized boards are used during game play. This prevents users from maliciously or unintentionally swapping out trusted components (e.g., second circuit boards) that could make game play unfair. This also maintains a uniform gaming experience for a multitude of users over a potential multitude of deployments by maintaining control over the trusted components that are installed in each electronic gaming terminal 110.

In embodiments, the electronic gaming terminal 110 can include a gaming cabinet or housing that electrically and mechanically supports each of the components, including a motherboard (e.g., the first circuit board), microcontroller circuit boards (e.g., both critical or non-critical components), a display (for example, a flat panel display or monitor) with a screen to display one or more game fields and/or images and for supporting play of various applications, which can include one or more electronic games, wiring, connectors, power supplies, etc. In addition, in various embodiments, the electronic gaming terminal 110 may comprise single player cabinet game or touch screen type gaming device for play of a gaming application 122.

In an embodiment, the electronic gaming terminal 110 can include a centralized or host control system having one or more processors (for example, microprocessors, CPUs, and/or other processors) that is in communication with the individually connectable or linkable player stations, which each having their own player station control systems, with one or more processors in communication with the centralized control system. The player station control systems communicate or cooperate with the centralized control system to send and receive instructions, feedback, workflows, and/or signals to facilitate game play and other functions of the gaming terminal.

Each of the player station control systems generally can be configured to control and/or provide processing of one or more actions of its corresponding game controls and monetary interface peripherals, as well as the audio and lighting features of the player station. The player station controls also can provide tactile or haptic feedback during game play. The centralized control system and the player station control systems access, run, and coordinate action of one or more actions or components of a gaming platform that provide for play of one or more games via the gaming terminal. For example, in embodiments, a gaming application can be run that enables electronic games to be played, e.g., electronic skill games that can include an environment of changing screens, colors, characters, elements, and/or other features, which can provide the appearance of randomness, but require an exercise of skill on the part of the player to win the game, and which also can include rules and identifiable patterns that a player can learn and use strategize against to develop their skill and ability at playing the game to consistently attain awards greater than the amount the player has spent (e.g., greater than 100% Return to Player (“RTP”)).

In embodiments, the platform controller 102 can comprise a motherboard or a first circuit board) may serve as the centralized control system for the terminal, and can include one or more processors (e.g., processor 106 which may include one or more microprocessors, CPUs, and/or other processors), and memory 120 which may represent a variety of one or more memory devices such as ROM, RAM, volatile and/or other non-volatile memories, that store instructions, including game rules, fill operations, and/or instructions and other programming, that when accessed and executed by the one or more processors facilitate game play, fill or play updates, and other operations/functions of the gaming terminal. In an embodiment, the centralized control system includes a centralized PC system controller with at least one processor and a memory; however, other suitable computing hardware can be used without departing from the scope of the present disclosure. The centralized control system further can include a graphics adapter, or a suitable interface connector configured to accept a graphics card. Still further, the centralized control system can include one or more hubs, such as one or more USB port hubs that connect to one or more controllers of a motherboard of the player station control systems.

In embodiments, the electronic gaming terminal 110 generally can include one or more gaming platforms or gaming programs/applications that include programming or instructions for one or more electronic games or other applications. Such programming or instructions can include producing a video playfield on the display of the electronic gaming cabinet, which playfield is used by one or more players (e.g., accessing the controls of a corresponding player station, or by direct interaction with the gaming terminal such as through a touchscreen) The gaming platform can include computer programs instructions, workflows and/or code that are accessed and executed by the processors to facilitate play of the one or more games. In one embodiment, the electronic gaming terminal can be provided at a remote location, for example, at an amusement center, gas station, grocery store, airport, and/or other similar locations, where the electronic gaming terminal is under ownership and/or operation of a third party.

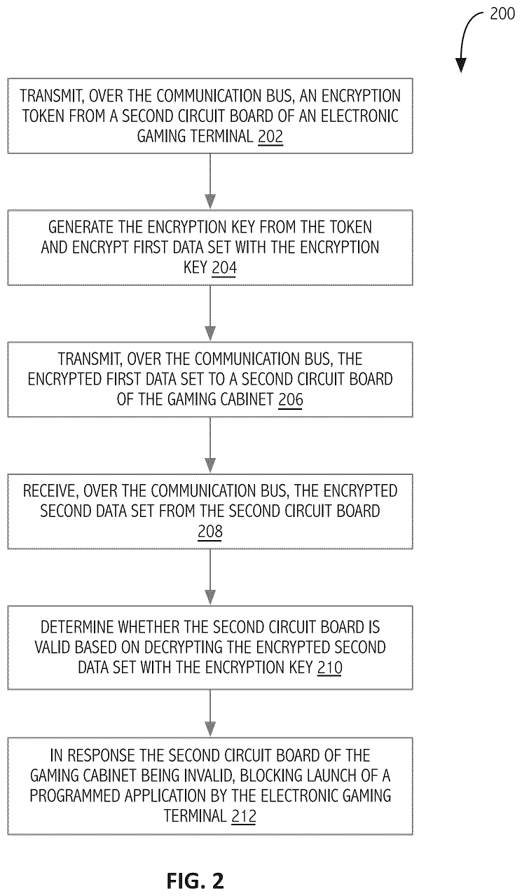

FIG. 2 shows a flow diagram depicting a method 200 or validating trusted components of an electronic gaming terminal, in accordance with an embodiment. The methods described herein may be run as a set of instructions of the system. Reference is made in FIG. 2 to communications between a first circuit board or motherboard (e.g., the platform controller), and one or more second circuit boards (e.g., one or more component controllers).

The method 200 may be performed by processing logic of the electronic gaming terminal that comprises hardware (e.g., passive or active electronic components, programmable logic, a processor, a transmitter, a receiver, an antenna, analog to digital converters, digital to analog converters, etc.), software (e.g., machine-executable instructions stored in computer-readable memory), or a combination thereof. The method may be performed by processing logic of a first circuit board of an electronic gaming terminal.

Although the example method depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence. Aspects described with respect to FIG. 2 may correspond to components described with respect to any of the other figures.

At block 202, processing logic transmits, over a communication bus, an encryption token from a second circuit board of an electronic gaming terminal. In an embodiment, the communication bus comprises a universal serial bus (USB).

In an embodiment, transmitting the encryption token from the second circuit board is performed over an encrypted channel, using a session key. Processing logic may generate the new encryption key for a subsequent session from the encryption token that was received from the second circuit board. The first circuit board may then use the new encryption session key to encrypt messages over the communication bus.

In an embodiment, to generate the session key, processing logic receives an encryption token, which can be a unique ID from the second circuit board, then generates the session key based on hashing the encryption token with a hashing algorithm.

In an embodiment, to generate the encryption key, processing logic accesses the encryption token. The token may be accessed from the USB communication bus of the second circuit board (e.g., from a memory stick or from a wireless USB dongle. Processing logic may apply a second hash algorithm to the token and to the unique ID, to generate the encryption key. In an embodiment, the encryption key may comprise any symmetric encryption key.

In certain embodiments, the hashing algorithm used for generating the encryption key may be selected from a group of industry-standard algorithms, such as SHA-256, SHA-3, or HMAC constructions, and may be programmable via system firmware. The platform controller and each trusted component controller may be configured to negotiate or select the algorithm to use during initial provisioning or during a secure firmware update process, allowing for field-upgradeable cryptographic algorithms and compliance with evolving security standards.

In an embodiment, the second circuit board also generates the session key based on hashing the encryption token, which can be a unique ID with a third hashing algorithm. The encryption token may be a unique microprocessor ID which the second circuit board has access to in local memory storage. Similarly, the third hashing algorithm may be stored in local memory (e.g., in protected flash memory). In an embodiment, the first hashing algorithm (used by the first circuit board) and the third hashing algorithm (used by the second circuit board) are the same, to generate the same session key. The session key may be a one-time use key that is discarded after the encryption token is shared from the second circuit board to the first circuit board.

At block 204, processing logic encrypts first data set with the encryption key. In an embodiment, the first data set may represent payload data. Generally, encrypting original data with an encryption key may refer to applying an encryption algorithm with the encryption key (e.g., a string of characters or numbers) to change the values and/or length of the original data according to the encryption algorithm and the encryption key. For example, the encryption algorithm may comprise an advanced encryption algorithm which is a block cipher with a chunk size of 128 bits. Such an algorithm converts each chunk of the original data using an AES key (of 128, 192, or 256 bits) to encrypted blocks, which the algorithm then joins together to form the encrypted original data in the form of ciphertext. AES is a symmetric-key algorithm, such that the same AES key may be used for both encrypting and decrypting data. Embodiments of the present disclosure may be a variety of encryption algorithms and encryption keys, without departing from the scope of the present disclosure.

At block 206, processing logic transmits, over the communication bus, the encrypted first data set to a second circuit board of the gaming cabinet. In an embodiment, processing logic may transmit the first data set which may be accompanied with (e.g., preceded with) one or more additional unencrypted bytes that indicate the message type (e.g., a msg ID), the message or payload length, etc., Transmission of the encrypted first data set may serve as an initial request of a digital handshake between the processing logic and the second circuit board.

At block 208, processing logic receives, over the communication bus, encrypted second data set from the second circuit board. Encrypted second data set may also be received with accompanying one or more additional unencrypted bytes that indicate a message type, message or payload length, etc. Generally, a message type may be used by the first circuit board or second circuit board to identify the type of message, such as identifying that the received message is a request from the first circuit board to authenticate the second circuit board, or a response from the second circuit board to the request from the first circuit board.

At block 210, processing logic determines whether the second circuit board is valid based on decrypting the encrypted second data set with the encryption key. The second data set may be determined based on the first data set. For example, it may be a look up value in response to the first data set, or identical to the first data set, or a hash of the first data set. In an example, the second data set may be validated by comparing the second data set to an expected or agreed upon value. For example, if the agreed upon handshake is to determine the second data set based on a lookup table, the first circuit board may perform a reverse lookup of the second data set to see if the result matches the first data set. If the second data set is a hash of the first data set, processing logic can hash the first data set and compare the result with the hashed second data set to confirm that they match, and so on.

In some embodiments, the validation of a trusted component controller may further comprise receiving, from the component controller via the communication bus, USB device information including a Vendor ID and a Product ID following enumeration by the operating system. The platform controller may compare the received Vendor ID and Product ID against a stored list of approved identifiers in memory. If the received identifiers correspond to an authorized component, the component controller is recognized as valid for further operation. If the identifiers do not match any authorized entry, the platform controller may block activation of the associated component or prevent launch of the gaming application. This validation step may be performed in addition to, or as an alternative to, cryptographic validation of the component controller.

At block 212, in response to the second circuit board of the gaming cabinet being invalid, processing logic blocks launch of a programmed application. For example, processing logic may halt current boot of a gaming application, or otherwise halt or prevent the gaming application from starting. Additionally, or alternatively, in an embodiment, processing logic may end a currently running application in response to detecting one or more conditions (e.g., game play exceeds an expected threshold range, electric power exceeds an expected threshold range, user input exceeds an expected threshold range, one or more cabinet doors are detected to be open, etc.).

In an embodiment, the second circuit board (e.g., a component controller) is one of a plurality of second circuit boards (e.g., a plurality of trusted component boards). Processing logic checks validity of each of these second circuit boards upon each start-up of the electronic gaming terminal. In an embodiment, the plurality of second circuit boards comprise at least one, at least two, or all of the following components: a cabinet lighting controller that is configured to operate lighting of the electronic gaming terminal, an input output (I/O) controller that is configured to route input and output signals of the electronic gaming terminal, a power management circuit board that is configured to operate one or more power supplies of the electronic gaming terminal, and a player deck controller that is configured to receive user inputs associated with gameplay of the gaming application.

The system may also provide for validation of additional types of trusted component controllers, such as a power controller, a network interface controller, or a touchscreen input controller, in a manner analogous to the lighting controller and player deck controller. In such examples, the component may implement the same key exchange, device enumeration, and validation protocols, ensuring security and integrity for diverse subsystem components within the electronic gaming terminal.

In an embodiment, processing logic can generate and transmit to each of the plurality of second circuit boards, a different encryption key. Each encryption key is generated based on the received encryption token of the respective second circuit board.

In an embodiment, block 206 (transmitting the encrypted first data set to the second circuit board) is performed in response to a start-up of the electronic gaming terminal, prior to launching of the gaming application. Processing logic performs this validation each time the electronic gaming terminal starts or is reset. The blocks 206, 208, 210, and 212 may be understood as a validation step performed on each start up or reset. Additionally, or alternatively, in an embodiment, validation may be performed in response to detecting one or more conditions, such as, for example, voltages or currents being out of a threshold range, game play results being out of range, one or more detected switch states (e.g., a cabinet door is detected to be open), or other condition.

In some embodiments, the platform controller may periodically re-validate each trusted component controller after initial boot, such as upon each system reset, restart, or upon detection of reconnection on the communication bus. The re-validation process may include re-transmitting the encryption key, receiving updated device information, and performing the cryptographic challenge-response protocol described above to ensure continued integrity of the system throughout operation.

In an embodiment, in response the second circuit board of the electronic gaming terminal being invalid, processing logic sets a default encryption key to be applied during the validation on a subsequent start-up of the electronic gaming terminal. For example, processing logic may save a setting in memory (e.g., non-volatile memory) that processing logic reads on the subsequent start up. In response, when processing logic performs the validation of the second circuit board, processing logic uses the default encryption key, rather than the encryption key that was previously shared to the second circuit board at block 202. The second circuit board may have this default encryption key stored in local protected memory and be configured to use this default encryption key in the case that it does not recognize encrypted first data set when it receives an authentication request.

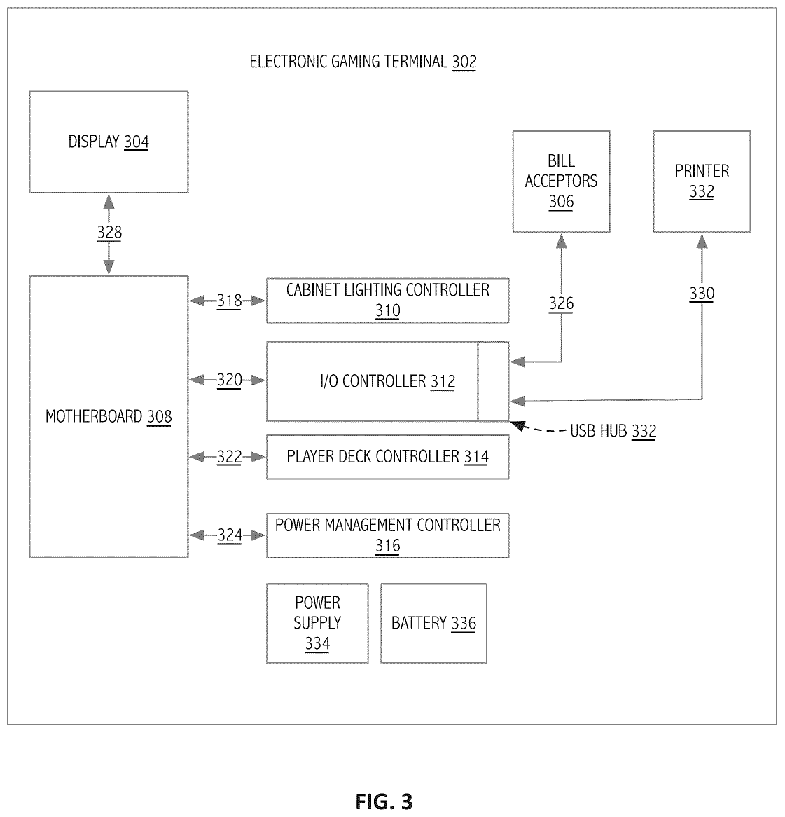

FIG. 3 depicts an electronic gaming terminal 302 with enhanced component validation, in accordance with an embodiment. FIG. 3 illustrates an example embodiment of the electronic gaming terminal of FIGS. 1A-1B, and may correspond to methods and operations described in other sections.

As illustrated in FIG. 3, the motherboard 308 may correspond to the platform controller 102, and trusted components such as cabinet lighting controller 310, I/O controller 312, player deck controller 314, and power management controller 316 may correspond to the component controllers 104 as previously described. The numbering in the following description may refer to the same components with the appropriate figure-based part numbers.

The electronic gaming terminal 302 may comprise a motherboard 308 which may correspond to the platform controller and can comprise a first circuit board. Cabinet lighting controller 310, I/O controller 312, player deck controller 314, and power management controller 316 may correspond to second circuit boards 104 and may be referred to as trusted components. The motherboard 308 may validate each of these trusted components, each time electronic gaming terminal 302 starts or is reset.

Motherboard 308 may communicate with the various components over respective communication buses. In an example, communication buses 318, 320, 322, and 324 are encrypted USB channels. In an embodiment, motherboard 308 comprises an x86 architecture. The motherboard 308 encrypts communications that are transmitted to cabinet lighting controller 310, I/O controller 312, player deck controller 314, and power management controller 316, and vice versa. The communication channels are encrypted using a symmetric encryption key. The encrypted communication may be part of validation of the boards. In addition, other messages may also be encrypted, that contain potentially sensitive data.

Each of the controllers (310, 312, 314, 316) may comprise a respective microprocessor and USB port to communicate to motherboard 308 over the respective encrypted USB channels 318, 320, 322, and 324. In addition, motherboard 308 may communicate with additional electronic components such as, for example, display 304, bill acceptors 306, and printer 332. In an embodiment, motherboard 308 communicates with display 304 over one or more communication buses 328. Buses 328 may comprise an HDMI, DisplayPort or extended display identification data (EDID), a touchscreen USB, or combination thereof. The EDID values may be used to ensure a supported LCD display is used in the cabinet. Communication buses 326, 330, and 328 may comprise USB channels that are not encrypted. Although these additional components 304, 306, 332 may not be trusted components, motherboard 308 may validate these components through non-encrypted messaging such as by receiving an expected unencrypted message. In the present application, a USB communication interface may comprise one or more USB ports.

Generally, cabinet lighting controller 310 may be configured to drive one or more cabinet lights (e.g., light emitting diodes in a strip). Motherboard 308 may transmit one or more messages to the cabinet lighting controller 310 at various times to alter the state of the lighting in the controller. In an example, the gaming application (e.g., gaming application 122) may be coupled to light controls-depending on the state of the game, different commands are generated based on the current state of the gaming application 122 and transmitted from the motherboard 308 to the cabinet lighting controller 310 to produce a desired light state. The cabinet lighting controller 310 may comprise a microprocessor that is programmed to perform logic such as decoding messages and generating outputs, routing the output control signals to turn cabinet lights on, off or alter the intensity and/or color of each individual LED.

Input Output I/O controller 312 may be configured to read a variety of sensors (e.g., meters) and input states such as key switches operated by an attendant or operator, an intrusion switch that may detect whether a cash door, a main door, and/or a logic box is open, button states, etc. The I/O controller 312 can multiplex this data and transmit it back to the motherboard 308. I/O controller 312 may comprise an I/O board that may be connected to an I/O backplane over one or more interfaces such as, for example, a Peripheral Component Interconnect Express (PCIe) interface. The I/O controller 312 receives the various inputs, digitizes and multiplexes them, and transmits them to the motherboard periodically (e.g., every 5 seconds), or in an event-driven manner (e.g., in response to detecting the cash door is open), or both.

Player deck controller 314 may comprise game play specific human machine interface controls such as, for example, a joystick controller, one or more buttons, a slider, a roller, a mouse, a touchscreen display, or other control or combination thereof. Player deck controller 314 may digitize and multiplex these inputs and transmit them to the motherboard 308.

The player deck controller in some embodiments may further include logic to buffer input data if encrypted communication with the motherboard is temporarily unavailable, for example, during a key exchange or re-validation event. Once communication is re-established and validation completed, the buffered input data may be transmitted for processing. This prevents loss of player inputs during trusted component maintenance or validation routines and ensures robust operation even in adverse conditions.

Power management controller 316 may include an electronic circuit (e.g., analog to digital converters (ADCs), comparators, etc.) configured to sense and monitor voltage and current of one or more power supplies 334 within the electronic gaming terminal 110. Power supply 334 may convert incoming AC voltage (e.g., 120 VAC, 240 VAC, etc.) to a lower voltage DC power source (e.g., 5V, 12V, 24V, etc.) that is used to power the electronic components in the electronic gaming terminal 302. Power management controller 316 may perform battery charging by controlling power switching to battery 336, for example, by turning battery charging on when main external power satisfies a threshold power. Power management controller 316 may switch between powering the various components with the power supply 334 or with the battery 336. The power source (power supply 334 or battery 336) may be determined based on the energy stored in the battery 336 or the presence of main power, or both.

Power management controller 316 may comprise one or more bus bars and discrete power switches to perform a sequential power up of the components at a desired time sequence. For example, power management controller 316 may, at time t1, increase voltage to component A at a rate of Y until the desired voltage is met, and at time t2, increase voltage to component B at a rate Y until the desired voltage is met, and so on, until all the components are powered in the desired sequence. Power management controller 316 may report the state of power (e.g., if a fault condition is present or not, or whether battery 336 or power supply 334 is being used as the power source) to motherboard 308 over the respective communication bus.

In an embodiment, some or all communications between the trusted component boards and the motherboard include encrypted data, such as during start-up of the electronic gaming terminal 302, or while the gaming application is running (e.g., during gameplay), or when the gaming application is ready to start a game, but a game has not been initiated and is not ongoing (e.g., idle).

In an embodiment, some of the functionality of the components and overall system functionality thereof are combined. For example, the cabinet lighting controller 310 may be integral to the display 304 or vice versa, and in such a case, some communications between the motherboard 308 and the combined component may be encrypted. Reference FIG. 3 shows one example of communication and routing between components, and different arrangements of the components and combinations thereof may be implemented while remaining in the scope of the present disclosure.

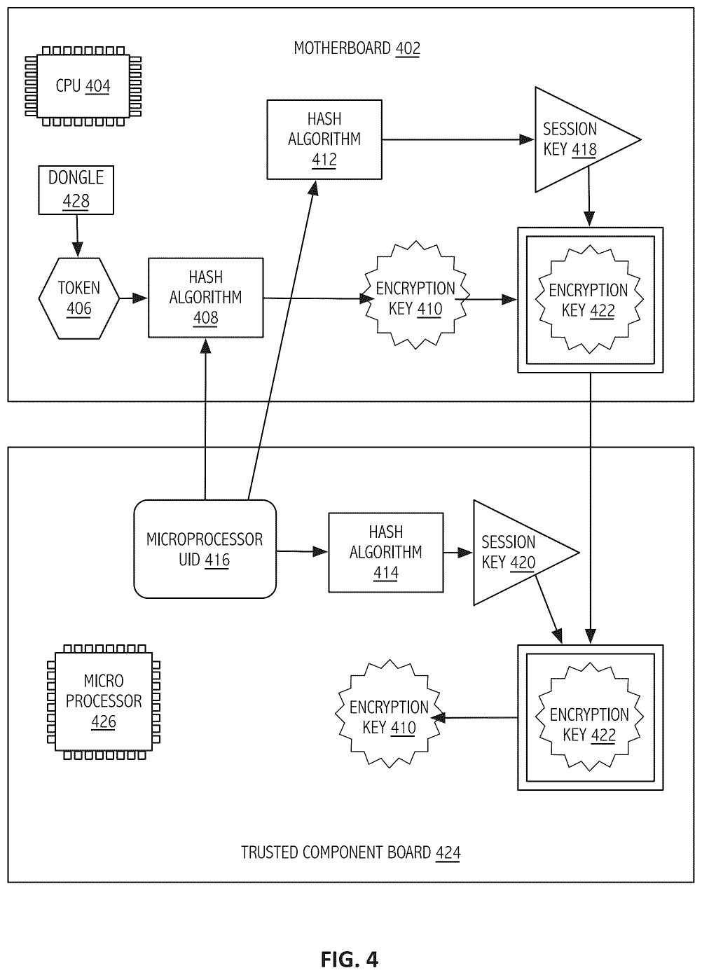

FIG. 4 shows an example of key generation and sharing, in accordance with an embodiment.

Motherboard 402 may comprise a CPU 404 that is configured to initiate and coordinate key sharing with trusted component board 424. Motherboard 402 may correspond to a platform controller and may comprise a first circuit board. In embodiments, the motherboard 402 may serve as the central controller of the electronic gaming terminal, in charge of launching and running a gaming application. Trusted component board 424 may correspond to a component controller 104 which may comprise a second circuit board, and which may be configured to serve a variety of roles in an electronic gaming terminal as described in other sections.

To generate the encryption key 410, motherboard 402 may access a token 406. In an embodiment, motherboard 402 obtains the token 406 by querying a dongle connected to a USB port of the motherboard 402. The dongle may be a USB memory stick which stores the token 406, or a wireless communication dongle (e.g., Bluetooth, WI-FI, etc.) that obtains the token 406 over the wireless communication from an external device. In an embodiment, the motherboard 402 is configured to detect when a dongle 428 is present, and in response to the dongle 428 being present, generate the encrypted key 422 and share it with trusted component board 424. In such a manner, authorized personnel may update or reprogram motherboard 402 by attaching the dongle 428 to the motherboard 402 and generate a new encryption key 410 based on a new or different token 406.

The motherboard 426 may apply hash algorithm 408 to the token 406 and to the microprocessor unique identifier (UID) 416 to generate the encryption key 410. The encryption key 410 may be a 128 byte or 256 byte key. Microprocessor unique ID 416 may be a unique serial number of microprocessor 426. Each trusted component board 424 has its own microprocessor 426 with its own unique identifier thereby yielding a unique encryption key 410 for each trusted component board 424.

To generate the session keys 418 and 420, the trusted component board 424 may transmit a microprocessor unique ID 416 to the motherboard 402 over a communication bus (e.g., a USB). Motherboard 402 may generate session key 418 by applying a hash algorithm 412 to a microprocessor unique ID 416. A hash algorithm may comprise a secure hash algorithm, such as SHA1 or SHA2 that mathematically maps data of any size to a fixed or designated size of values. The resulting fixed or designated size of values is hash value that is used as the session key 418.

The trusted component board 424 generates an identical session key 420 by applying the same hash algorithm 414 to the same microprocessor unique ID 416. Hash algorithm 414 and hash algorithm 412 may be stored in respective local memory on the motherboard 402 and trusted component board 424.

The motherboard 402 may comprise an operating system (OS) service that applies the session key 418 to encryption key 410, resulting in an encrypted version 422 of encryption key 410. The motherboard 402 transmits the encrypted key 422 to the trusted component board 424 over a communication bus such as USB. The trusted component board 424 receives the encrypted key 422 and then decrypts it using session key 420.

Trusted component board 424 and motherboard 402 may store same encryption key 410 in respective local memory, such as non-volatile memory. The encryption key 410 may now be used by the motherboard 402 and trusted component board 424 to communicate encrypted data to each other in a validation process, as described in other sections. In an embodiment, once the motherboard 402 and trusted component board 424 have the encryption key 410, the session key 418 and session key 420 may be discarded by each board.

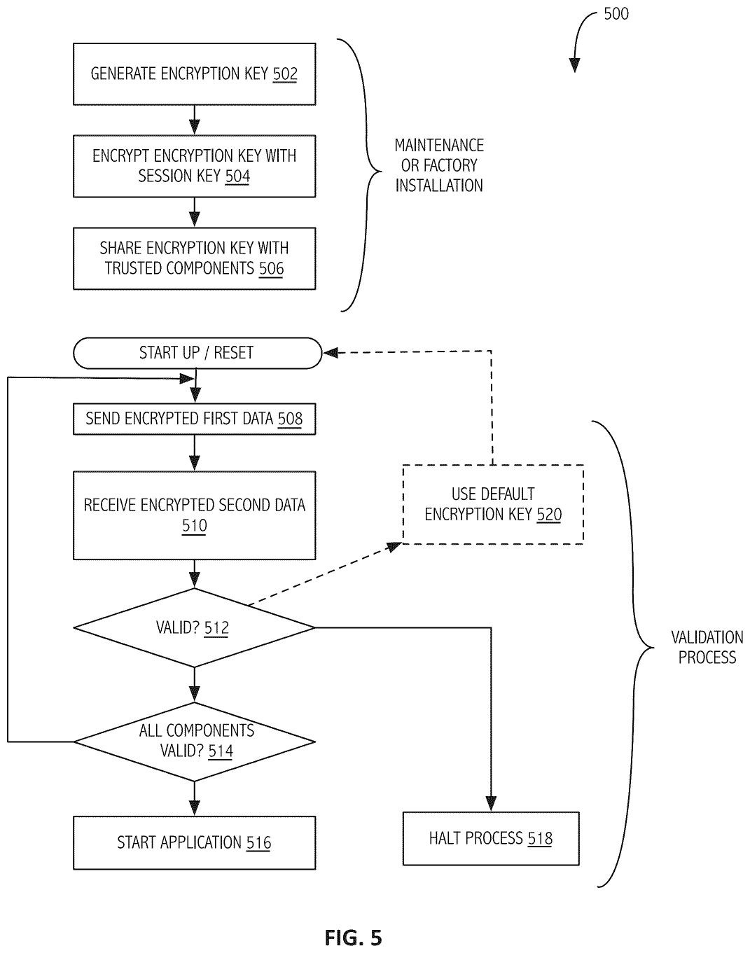

FIG. 5 shows a flow diagram depicting a method 500 for validating trusted components of an electronic gaming terminal, in accordance with an embodiment. The methods described herein may be run as a set of instructions of the system (e.g., the motherboard 402 or first circuit board). In some embodiments, the set of instructions may be part of an application installed on the first circuit board.

Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence. Aspects described with respect to FIG. 5 may correspond to components described with respect to FIG. 4.

At block 502, processing logic generates an encryption key. In an embodiment, this encryption key may be generated based on a microprocessor unique identifier (UID) of a trusted component, and a token, as described with respect to FIG. 4.

At block 504, processing logic encrypts the encryption key with a session key. The session key may be generated based on the microprocessor unique identifier of the trusted component and a hashing algorithm, as described with respect to FIG. 4. The microprocessor unique identifier may be unique to each microprocessor, and no two microprocessors have the same unique identifier. As such, each trusted component board may have a different unique identifier.

At block 506, processing logic shares the encryption key with the trusted components. Processing logic may transmit, to each trusted component, a respective encryption key, which is embedded in an encrypted message payload. The trusted component may use its locally stored session key to decrypt the encryption key and store the received encryption key locally.

In an embodiment, blocks 502, 504, and 506 may be performed during a factory installation phase when the electronic gaming terminal is assembled and provisioned. Additionally, or alternatively, blocks 502, 504, and 506 may be performed by an authorized user during maintenance or repair. In an embodiment, blocks 502, 504, and 506 may be initiated by booting the system with a memory stick installed in a USB port of the first circuit board, having the token. In response, the platform controller recognizes that the memory stick is installed in the USB port, accesses the token, and generates the encryption key for each trusted component board based on the token and the unique ID received for each trusted component. Blocks 502, 504, and 506 may be understood as a key generation and sharing operation, where the generated and shared encryption key is subsequently used in the electronic gaming terminal to validate the trusted component.

At block 508, processing logic transmits encrypted first data set to a trusted component board. As described, this may be referred to as an authentication request that seeks to garner a recognizable response from the trusted component board.

At block 510, processing logic receives encrypted second data set from the trusted component board. Processing logic applies the encryption key (generated at block 502) to the encrypted second data set to decrypt the second data set.

At decision block 512, if the received second data set reads as expected (e.g., an expected value, format, and/or order), processing logic may deem the trusted component to be valid. If the second data set is not as expected (e.g., the data packets do not comprise expected order of fields or values), then processing logic may deem the trusted component to be invalid. Similarly, if second data set is not received at all or not within a threshold time since the transmission of the first data set, processing logic may deem the trusted component to be invalid. Invalidity may be an indication that the trusted component has been replaced or otherwise tampered with.

In response to deeming that the trusted component board is valid, processing logic may proceed to block 514 and, if all trusted components have been deemed to be valid, processing logic may proceed to block 516 and start the gaming application. Otherwise, if additional trusted component blocks are still to be validated, processing logic repeats the validation process with remaining not-yet validated trusted components, until all are validated.

If, at decision block 512, the trusted component is deemed to be invalid, processing logic may proceed to block 518 and halt the process. In such a case, processing logic does not launch the gaming application.

In an optional embodiment, at block 520, when a trusted component is deemed to be invalid, processing logic may also revert to a default encryption key. Processing logic may set a value in a register or other memory (e.g., local to the motherboard) so that, upon the very next boot up of the electronic gaming terminal, processing logic encrypts first data set with the default encryption key and transmits this to the trusted component for validation.

In embodiments, each of the trusted components may comprise internal logic that first tries to decrypt the first data set with the transmitted encryption key, but if that fails, also may revert back to the default encryption key. The trusted component may use the default key to decrypt the first data set, and if it yields recognizable data, encrypt its response (e.g., second data set) with the default key. Processing logic may receive the second data set, decrypt it with the default key, and proceed to validate the trusted component.

In embodiments, the default key may be stored in protected memory on the motherboard and on each trusted component board. The default key may be stored in protected non-volatile memory. In an embodiment, the default key may be embedded in protected program memory. Memory may be protected via bit protection (e.g., setting a dedicated bit) upon programming of the motherboard and/or trusted component. Protected refers to disabling reading of the memory from an outside source.

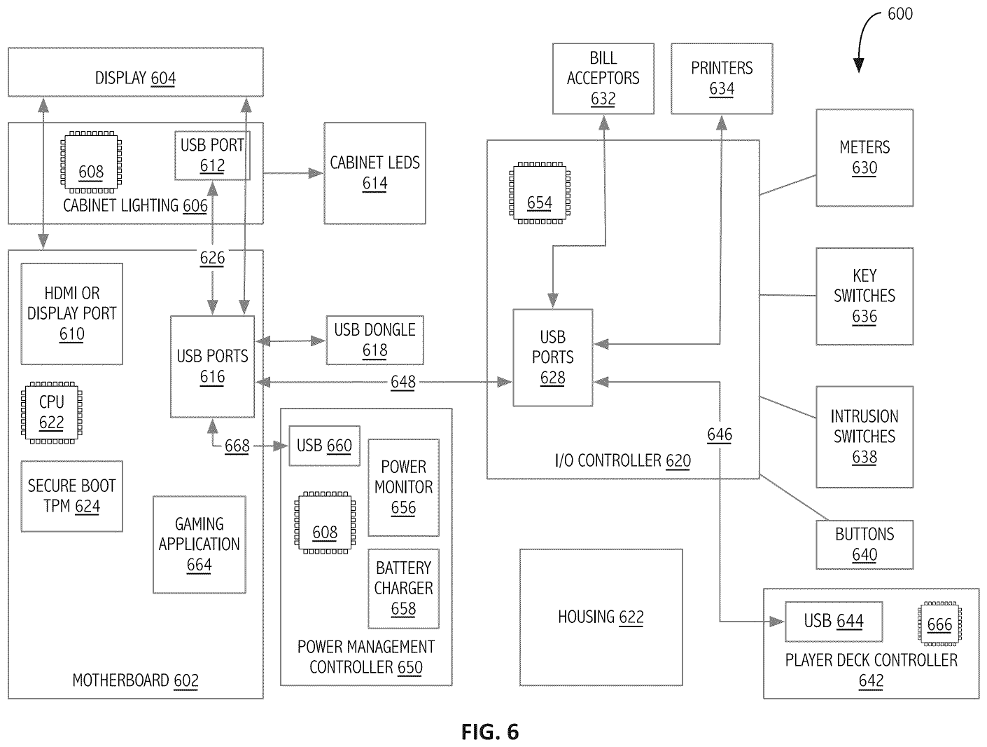

FIG. 6 depicts an example electronic gaming cabinet 600 with an example arrangement of trusted components, in accordance with an embodiment. Electronic gaming cabinet 600 may comprise a housing 662 that comprises one or more walls, as well as infrastructure such as shelves, brackets, etc., to house the various components. Housing 662 may comprise one or more removable panels, doors, openings, etc., to allow for access to the components, ventilation, wire routing, and other required infrastructure for the operation of the internal components.

As shown in FIG. 6, the motherboard 602 corresponds to the platform controller 102, and controllers such as cabinet lighting controller 606, I/O controller 620, player deck controller 642, and power management controller 650 correspond to the second circuit boards or trusted components 104 as previously described. The description herein uses figure-based part numbers when referring to these components.

Internal components may comprise motherboard 602 which includes a CPU 622 that is configured to run gaming application 664 and operate and coordinate various other inputs and outputs, as described.

A display 604 may comprise an LCD display that communicates with the motherboard 602 over HDMI or display port 610. In an embodiment, display 604 may comprise a touchscreen display and associated hardware and software to recognize and localize input through the touchscreen display. The touchscreen display may communicate user inputs to the motherboard 602 through USB ports 616.

A cabinet lighting controller 606 may comprise a microprocessor 608 and USB port 612 that is coupled to USB ports 616 of the motherboard 602. Cabinet lighting controller 606 is configured to generate one or more outputs to cabinet LEDs 614.

I/O controller 620 may comprise a microprocessor 654 and one or more USB ports 628. USB ports 628 may comprise separate sets of USB ports, some dedicated to non-encrypted channels (e.g., to bill acceptors 632 and printers 634), and others dedicated facilitating encrypted communication with other trusted components (e.g., player deck controller 642). In an embodiment, player deck controller 642 comprises a microcontroller 666 and USB port 644 that is communicatively coupled to USB ports 628. I/O controller 620 may receive inputs from one or more meters 630, key switches 636, intrusion switches 638, and buttons 640.

Power management controller 650 may comprise a microprocessor 652 and USB port 660 that is connected to USB ports 616 of the motherboard 602. Power management controller 650 may comprise a power monitor 656 and a battery charger 658, each of which may comprise hardware (e.g., electric or electronic circuits) or software, or a combination thereof to monitor electric power used in the electronic gaming cabinet 600, and to charge a battery of electronic gaming cabinet 600, as described in other sections.

During power up or a reset, motherboard 602 may execute logic of secure boot trusted platform module (TPM) 624, which may include protected memory that stores that operations executable by one or more processors of motherboard 602. The logic may be executed by CPU 622 or a dedicated boot processor or logic that is integral to secure boot trusted platform module (TPM) 624. Motherboard 602 may generate an encryption key based on a token obtained through USB dongle 618 and share an encrypted version of this encryption key over communication buses 626, 648, 668, 646, as described. Subsequently (e.g., during each power up or reset), the motherboard 602 executes logic to validate each of the trusted components (e.g., cabinet lighting controller 606, power management controller 650, I/O controller 620, and player deck controller 642) using the generated encryption key. If any of the trusted components fail validation, motherboard 602 may prevent gaming application 664 from launching.

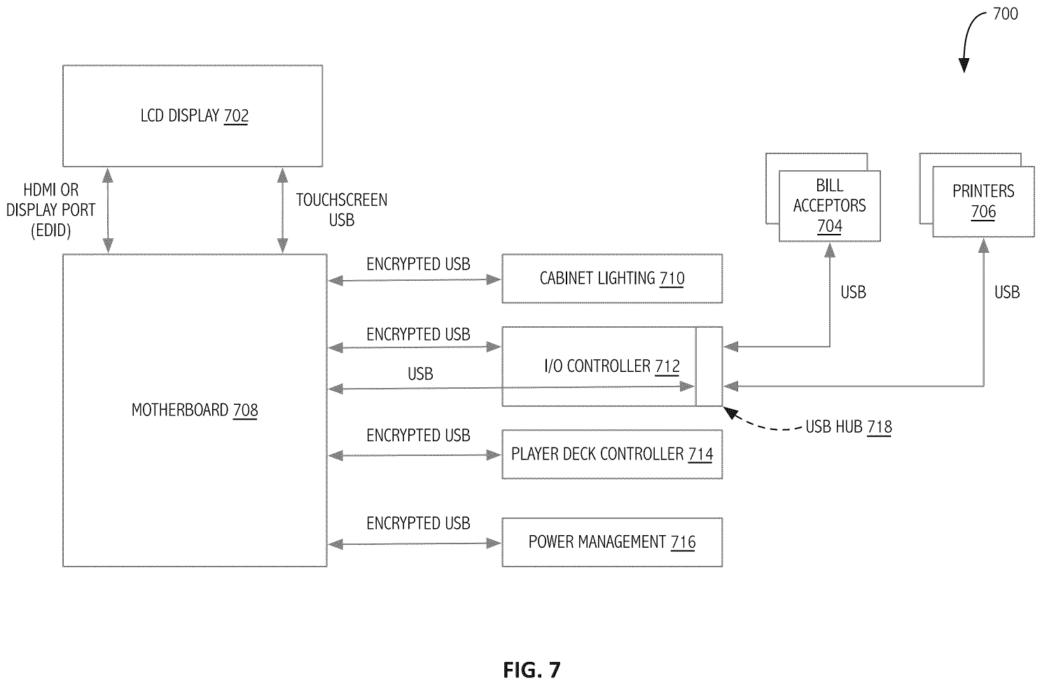

FIG. 7 depicts an example electronic gaming cabinet with validation of components, in accordance with an embodiment. The electronic gaming cabinet 700 may comprise a controller 708 that may correspond to platform controller, first circuit board, or motherboard, as described in other sections.

In FIG. 7, the controller 708 may correspond to the platform controller 102 or motherboard 308, and the cabinet lighting controller 710, 10 controller 712, player deck controller 714, and power management controller 716 may correspond to trusted component controllers 104. Subsequent references to part numbers in the description align with the figure in context.

The controller 708 may comprise an x86 based processor (e.g., an Intel 8086 processor or variation thereof). The controller 708 may be communicatively coupled to an LCD display 702 via an HDMI or Display Port. LCD Display 702 may comprise a touchscreen display that senses and encodes touches on its display. LCD display 702 may communicate this touch data to the controller 708.

Controller 708 may communicate with one or more bill acceptors 704 and one or more printers 706 through USB. This USB communication may be unencrypted.

Controller 708 may communicate with cabinet lighting controller 710, 10 controller 712, player deck controller 714, and power management controller 716 over encrypted USB. Encrypted USB may refer to at least some of the data over the USB being encrypted with an encryption key, as described in other sections. The encrypted communications may be performed during the validation process of the controllers, or after (e.g., when a gaming application is in a startup process or idle), or both.

Controller 708 may validate each of the cabinet lighting controller 710, the 10 controller 712, the player deck controller 714, and the power management controller 716. This may be performed during each startup of the electronic gaming terminal 700, and at other times as needed.

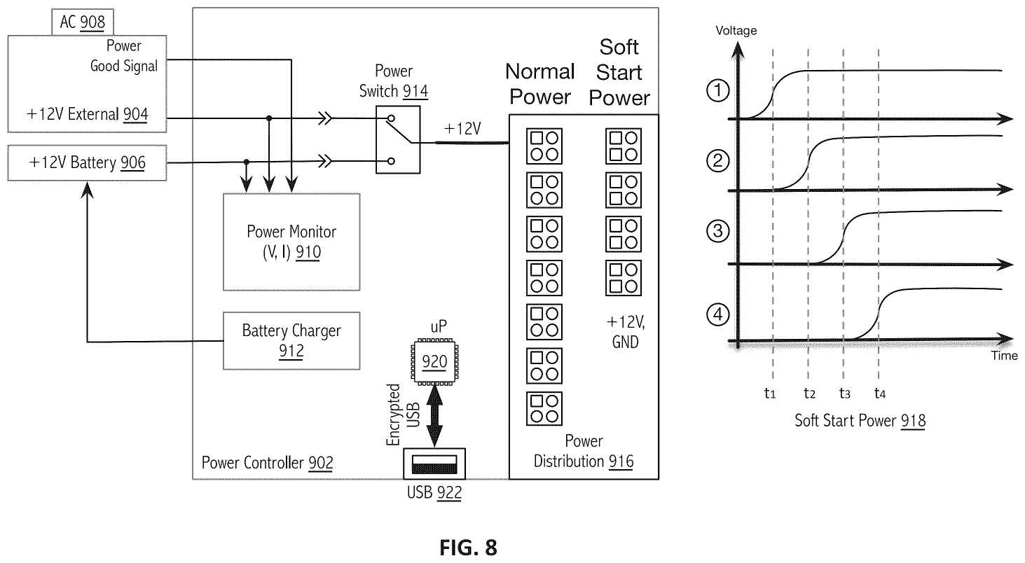

FIG. 8 shows an example of a power management controller 902, in accordance with an embodiment. Power management controller 902 may manage power for electronics within the electronic gaming terminal of any of the described embodiments.

Power management controller 902 may comprise a power monitor processing logic 910 that may monitor voltage or current or both, of power supplies 904 and battery 906. Processing logic 910, 912 may comprise analog to digital converters, comparators, or other electronic components. Power supply 904 may convert AC power 908 (e.g., grid power) to a DC voltage (e.g., 12V) that is suitable for electronics within the electronic gaming cabinet. Battery charging processing logic 912 may monitor voltage of a battery 906 which may comprise a 12V output. Together, processing logic 910 and 912 may determine power conditions to determine whether to power the electronics with the power supply 904 or with battery 906.

Microprocessor 920 may be coupled to USB port 922 via encrypted communications, as described. The controller 902 may send a message through USB 922 on power switching to/from the battery 906. The controller 902 may shut down the electronic gaming terminal on low battery or even a detected dead battery condition when external power is present. In an example, controller 902 performs battery charging when main external power is high enough (e.g., within an operational threshold).

In an embodiment, controller 902 may perform sequential station power up when initially starting up. For example, graph 912 illustrates that a first component may be powered up by controller 902 at time t1, and a second component is powered up by the controller 902 at time t2, and so on. By staggering power up, the power controller 902 may reduce the effect of transients or power dips which may occur when multiple components are started at the same time.

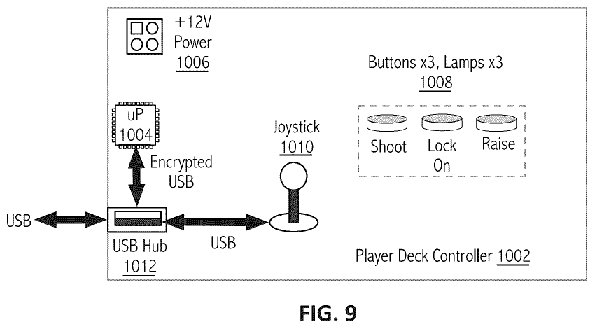

FIG. 9 shows an example of a player deck controller 1002, in accordance with an embodiment. The player deck controller 1002 may comprise a microprocessor 1004 that is communicatively coupled to USB port 1012 over USB.

The player deck controller 1002 may comprise one or more buttons 1008 and joystick 1010 for a user to provide in-game inputs. Microprocessor 1004 may process these inputs from the joystick 1010 and buttons 1008, such as digitization, encoding, multiplexing, etc. Once processed, the inputs are transmitted over encrypted USB to the motherboard either directly, or through an IO controller, as described in other sections. Player deck controller has terminals 1006 through which it receives a suitable voltage (e.g., 12 Vdc).

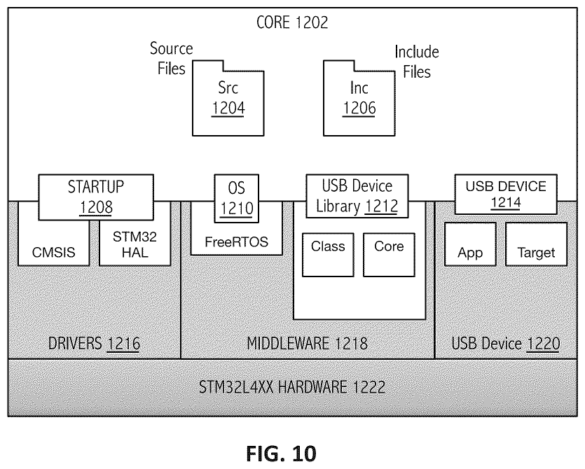

FIG. 10 shows an example architecture for processor components, in accordance with an embodiment. The architecture may be implemented by a controller or motherboard, as described in other sections. A processor 1222 such as an STM32L4XX or other processor may perform computer instructions (e.g., software) including drivers 1216, and middleware 1218. The processor 1222 may interface with a USB device 1220 on the motherboard.

In some embodiments, the motherboard or platform controller may provide an application programming interface (API) to allow software routines to retrieve the status of each trusted component's validation state. This API may permit system software to display status information, enable or disable specific functionality depending on component health, and facilitate remote monitoring or reporting. The API may expose calls for obtaining information such as the current encryption key identifier, the last validation time, error codes for failed validation attempts, and the state of default encryption key usage. These capabilities enable automated fleet management and maintenance scheduling in large gaming terminal deployments.

A core software 1202 comprises source files 1204 and includes files 1206 referenced by the source files. The core software 1202 may comprise startup logic 1208 that implements CMSIS (Cortex Microcontroller Software Interface Standard) and STM32HAL (hardware access layer) to operate drivers 1216, thereby performing data reads or control commands with peripherals, processors, and other components. Core software 1202 may comprise an operating system (1202) which may interface with FreeRTOS (real-time operating system) of middleware 1218. Core software 1202 interfaces with USB device library 1212, which may also include respective software classes and core software. Core software 1202 may access USB application programming interface (API) 1214 to perform communication with other devices over USB. Core software 1202 may comprise instructions that, when performed by a processing device, perform encryption key sharing and perform validation of the trusted components, as described in other sections.

In some embodiments, the instructions executed by each trusted component board's processor may include logic to attempt validation with a previously shared encryption key and, if unsuccessful, to fall back to a default encryption key stored in protected memory. The default encryption key may be used when the trusted component's local logic cannot decrypt a received authentication request using the most recently provisioned key, providing a secondary validation path. Upon successful default key validation, the system may prompt authorized personnel for maintenance, record an alert, or flag the event for audit purposes. This ensures that the platform controller and trusted component board may re-establish secure operation after component replacement or data corruption.

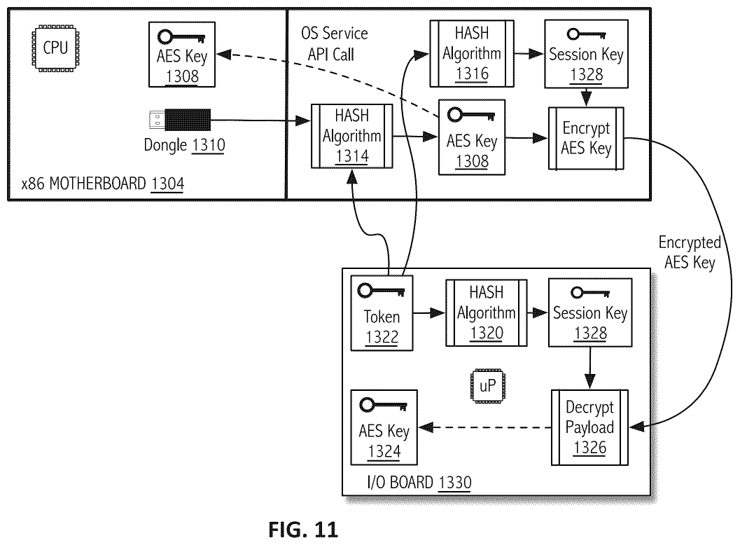

FIG. 11 shows a diagram illustrating an example of secure encryption key sharing, in accordance with an embodiment. In the example, motherboard 1304 may comprise an x86 architecture, but other processor architectures can be used by the motherboard. Similarly, although the example shows key sharing with an IO board controller 1330, the same key sharing operations are performed between the motherboard and the other controllers that are to be validated during the boot process, as described in other sections.

Motherboard 1304 and controller 1330 both generate a session key 1318 and 1328 respectively, from a unique microprocessor ID 1322 that is stored on the controller 1330. The unique microprocessor ID 1322 is used in a hash algorithm (1316, 1320) once for the encrypted key exchange. Both the OS service 1306 of the motherboard 1304 and the controller 1330 may use this session key (1316, 1328) once.

Dongle 1310 is queried by the motherboard 1304, for a token 1312 to be hashed with hash algorithm 1314. The hash algorithm 1314 may be applied to the token 1312 and to the unique microprocessor ID 1322. The hash algorithms (1316, 1320, 1314) may comprise the unique microprocessor ID 1332 already stored within (e.g., as part of the stored instructions) of the hash algorithm. The unique microprocessor ID 1332 may serve as a hash seed. The token 1312 is used along with the unique microprocessor ID 1322 in the hash algorithm 1314 to generate the encryption key 1308 which may comprise 128 bytes or 256 bytes. The encryption key 1308 is stored locally on the motherboard 1304 for future use to validate the controller 1330.

The session key 1318 and 1328 is used once by OS service 1306 to encrypt the encryption key 1308 for transmission to the controller 1330 in a secure manner. The encrypted key 1308 may be transmitted to the controller 1330 over USB or other suitable communication bus.

The controller 1330 receives the encrypted payload from the OS service 1306 on the motherboard 1304 and then decrypts the payload using the generated session key 1328. The resulting encryption key 1330 may be identical to the encryption key 1308. The controller 1330 stores the encryption key 1330 locally for future use during the validation process, as described in other sections.

Several variations and modifications of the disclosure can be used. It would be possible to provide for some features of the disclosure without providing others.

The present disclosure contemplates a variety of different gaming systems each having one or more of a plurality of different features, attributes, or characteristics. A “gaming system” as used herein refers to various configurations of: (a) one or more central servers, central controllers, or remote hosts; (b) one or more electronic gaming machines such as those located on a casino floor; and/or (c) one or more personal gaming devices, such as desktop computers, laptop computers, tablet computers or computing devices, personal digital assistants, mobile phones, and other mobile computing devices. Moreover, an EGM as used herein refers to any suitable electronic gaming machine which enables a player to play a game, wherein the EGM can comprise, but is not limited to: a slot machine, a video poker machine, a video lottery terminal, a terminal associated with an electronic table game, a video keno machine, a video bingo machine located on a casino floor, a sports betting terminal, or a kiosk, such as a sports betting kiosk.

In various embodiments, the gaming system of the present disclosure can include: (a) one or more electronic gaming machines in combination with one or more central servers, central controllers, or remote hosts; (b) one or more personal gaming devices in combination with one or more central servers, central controllers, or remote hosts; (c) one or more personal gaming devices in combination with one or more electronic gaming machines; (d) one or more personal gaming devices, one or more electronic gaming machines (EGM), and one or more central servers, central controllers, or remote hosts in combination with one another; (e) a single electronic gaming machine; (f) a plurality of electronic gaming machines in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

A central server, central controller, or remote host and an EGM (or personal gaming device) can be configured to connect to the data network or remote communications link in any suitable manner. In various embodiments, such a connection is accomplished via a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

As should be appreciated by one skilled in the art, aspects of the present disclosure have been illustrated and described herein in any of several patentable classes or context including any new and useful process, machine, manufacture, or composition of matter, or any new and useful improvement thereof. Accordingly, aspects of the present disclosure may be implemented entirely hardware, entirely software (including firmware, resident software, and/or micro-code) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, or any suitable combination of the foregoing.

Aspects of the present disclosure have been described herein with reference to flowchart illustrations and/or block diagrams of methods, apparatuses (systems) and computer program products according to embodiments of the disclosure. Each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

What is claimed is:

1. A method, performed by a platform controller of an electronic gaming terminal, comprising:
transmitting, over a communication bus, an encryption key to a component controller of the electronic gaming terminal;
encrypting a first data set with the encryption key;
transmitting, over the communication bus, the encrypted first data set to the component controller;
receiving, over the communication bus, an encrypted second data set from the component controller;
determining whether the component controller is valid based on decrypting the encrypted second data set with the encryption key; and
in response to a determination of the component controller of the electronic gaming terminal being invalid, blocking launch of a programmed gaming application by the electronic gaming terminal.

2. The method of claim 1, wherein transmitting the encryption key with the component controller comprises:
generating, by the platform controller, the encryption key;
generating, by the platform controller, a session key;
encrypting, by the platform controller, the encryption key with the session key; and
transmitting the encrypted encryption key to the component controller.

3. The method of claim 2, wherein generating the session key comprises:
receiving, by the platform controller, a unique identifier from the component controller, and
generating the session key based on hashing the unique identifier with a first hashing algorithm.

4. The method of claim 3, wherein generating the encryption key comprises:
accessing a token; and
applying a second hash algorithm to the token and to the unique identifier, to generate the encryption key.

5. The method of claim 4, wherein the component controller generates the session key based on hashing the unique identifier with a third hashing algorithm.

6. The method of claim 5, where the first hashing algorithm and the third hashing algorithm match.

7. The method of claim 1, wherein the encryption key is an advanced encryption key.

8. The method of claim 1, wherein the communication bus comprises a universal serial bus.

9. The method of claim 1, wherein the component controller is one of a plurality of component controllers of the electronic gaming terminal, comprising:
a cabinet lighting controller that is configured to operate lighting of the electronic gaming terminal,
an input output (I/O) controller that is configured to route input and output signals of the electronic gaming terminal,
a power management controller that is configured to operate one or more power supplies of the electronic gaming terminal, and
a player deck controller that is configured to receive user inputs associated with gameplay of the gaming application; and
the method is repeated to validate each of the plurality of component controllers.

10. The method of claim 1, further comprising:
in response the component controller of the electronic gaming terminal being invalid, setting a default encryption key to be applied to validate the component controller upon a subsequent start-up of the electronic gaming terminal.

11. An electronic gaming terminal comprising:
a platform controller;
wherein the platform controller comprises a processor and a computer-readable storage medium configured for storing instructions that, when executed by the processor, cause the platform controller to perform the following:
transmitting, over a communication bus, an encryption key to at least one component controller of the electronic gaming terminal in communication with the platform controller;
encrypting first data set with the encryption key;
transmitting, over the communication bus, the encrypted first data set to the at least one component controller;
receiving, over the communication bus, an encrypted second data set from the at least one component controller;
determining whether the at least one component controller is valid based on decrypting the encrypted second data set with the encryption key; and
in response to a determination of the at least one component controller of the electronic gaming terminal being invalid,
refraining from launching a gaming application.

12. The electronic gaming terminal of claim 11, wherein transmitting the encryption key with the at least one component controller comprises:
generating, by the platform controller, the encryption key;
generating, by the platform controller, a session key;
encrypting, by the platform controller, the encryption key with the session key; and
transmitting the encrypted encryption key to the at least one component controller.

13. The electronic gaming terminal of claim 12, wherein generating the session key comprises:
receiving, by the platform controller, a unique ID from the component controller, and
generating the session key based on hashing the unique ID with a first hashing algorithm.

14. The electronic gaming terminal of claim 13, wherein generating the encryption key comprises:
accessing a token;
applying a second hash algorithm to the token and to the unique identifier, to generate the encryption key.

15. The electronic gaming terminal of claim 14, wherein the at least one component controller generates the session key based on hashing the unique identifier with a third hashing algorithm.

16. A motherboard configured to control operation of an electronic gaming terminal, the motherboard comprising:
at least one processor including programming configured to perform operations comprising:
transmitting, over a communication bus, an encryption key from the motherboard to a component controller of at least one hardware component housed within gaming cabinet of the electronic gaming terminal;
encrypting first data set with the encryption key;
transmitting, over the communication bus, the encrypted first data set to the component controller;
receiving, over the communication bus, encrypted second data set from the component controller;
determining whether the component controller is valid based on decrypting the encrypted second data set with the encryption key; and
in response to a determination of the component controller being invalid, refraining from launching a gaming application.

17. The motherboard of claim 16, wherein the encryption key is an advanced encryption key.

18. The motherboard of claim 16, wherein the communication bus comprises a universal serial bus.

19. The motherboard of claim 16, further comprising a plurality of component controllers of a plurality of components housed in the gaming cabinet of the electronic gaming terminal, the plurality of component controllers comprising:
a cabinet lighting controller that is configured to operate lighting of the electronic gaming terminal,
an input output (I/O) controller that is configured to route input and output signals of the electronic gaming terminal,
a power management controller that is configured to operate one or more power supplies of the electronic gaming terminal, and
a player deck controller that is configured to receive user inputs associated with gameplay of the gaming application; and
wherein the motherboard repeats the operations to validate each of the plurality of component controllers.

20. The motherboard of claim 16, wherein the at least one processor further comprises programming configured to set for the component controller a default encryption key to be applied by the motherboard to validate the component controller upon a subsequent start-up of the electronic gaming terminal in response to a determination of the component controller being invalid.

21. The motherboard of claim 20, wherein the at least one processor is further configured to validate the component controller by checking a USB Vendor ID and a USB Product ID reported by the component controller after enumeration of the component controller as a USB device by an operating system, wherein the component controller is authorized for operation if the USB Vendor ID and the USB Product ID match a predetermined list of valid identifiers.
